(19) United States
(12) Patent Application Publication
(10) Pub. No.: US 2013/0176249 A1
(43) Pub. Date: Jul. 11, 2013

(54) ELECTRONIC DEVICE AND METHOD FOR UNLOCKING DISPLAY SCREEN OF ELECTRONIC DEVICE

(71) Applicants: SHENZHEN FUTAIHONG PRECISION INDUSTRY CO., LTD., Shenzhen (CN); Chi Mei Communication Systems, Inc., New Taipei (TW)

(72) Inventor: AN-MING WANG, Shenzhen (CN)

(73) Assignees: CHI MEI COMMUNICATION SYSTEMS, INC., New Taipei (TW); SHENZHEN FUTAIHONG PRECISION INDUSTRY CO., LTD., Shenzhen (CN)

(21) Appl. No.: 13/726,567

(22) Filed: Dec. 25, 2012

(30) Foreign Application Priority Data
Jan. 9, 2012 (CN) 201210004671.6

(51) Int. Cl. G06F 3/041

(52) U.S. Cl. CPC G06F 3/0414
USPC 345/173

(57) ABSTRACT

An electronic device includes a pressure sensor. When a display screen is in an activated state, the pressure sensor detects a pressure on a valid area of a display screen of the electronic device. The electronic device reads a value of the pressure from the pressure sensor. If the value of the pressure is more than a predefined pressure value, the display screen is unlocked.

### BACKGROUND

1. Technical Field

Embodiments of the present disclosure relate to electronic device controlling systems and methods, and particularly to an electronic device and a method for unlocking a display screen of the electronic device.

2. Description of Related Art

Many electronic devices such as mobile phones, or tablet computers, for example, include touch screens. A touch screen of an electronic device is often locked to avoid error operations when a user does not use the electronic device. If the user presses a power key of the electronic device and slides on the touch screen with a finger, the display screen is unlocked. Due to too many times of slicing the touch screen, the touch screen may be nicked.

### BRIEF DESCRIPTION OF THE DRAWINGS

FIG. 1 is a block diagram of one embodiment of an electronic device including an unlocking system.

FIG. 2 is a block diagram of one embodiment of function modules of the unlocking system in FIG. 1.

FIG. 3 is a flowchart illustrating one embodiment of a method for unlocking a display screen of an electronic device.

FIG. 4 is a schematic diagram illustrating one embodiment of a display screen displaying a pressure reading.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

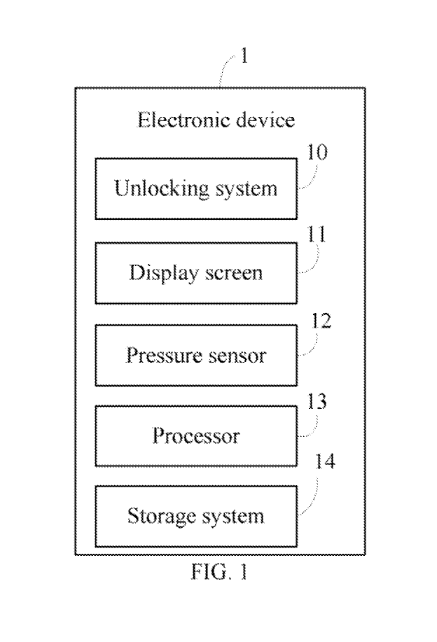

FIG. 1 is a block diagram of one embodiment of an electronic device 1 including an unlocking system 10. In some embodiments, the electronic device 1 may be a mobile phone, or a tablet computer. The electronic device 1 includes a display screen 11 and a pressure sensor 12. If the display screen 11 is in a locked state, the display screen 11 is unlit. When the display screen 11 is in an activated state, the display screen 11 is lit by a background light (not shown) and the display screen 11 is locked. In such a situation, when a user presses the display screen 11 with a finger, the pressure sensor 11 detects a pressure from the user's finger. If a value of the pressure is more than a predefined pressure value, the display screen 11 is unlocked.

In an embodiment, the electronic device 1 includes at least one processor 13 and a storage system 14. In one embodiment, the storage system 14 may be a magnetic storage system, an optical storage system, or other suitable storage medium.

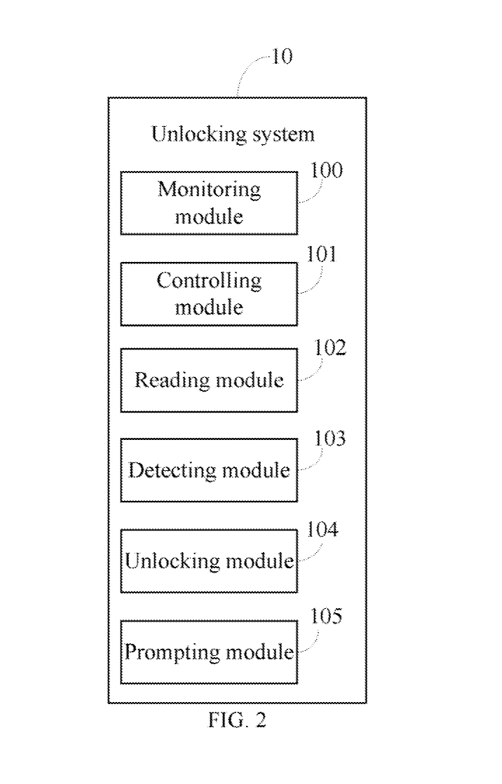

As shown in FIG. 2, the unlocking system 10 includes a monitoring module 100, a controlling module 101, a reading module 102, a detecting module 103, an unlocking module 104 and a prompting module 105. The one or more modules may comprise computerized instructions in the form of one or more programs that are stored in the storage system 14 and executed by the at least one processor 13 to provide functions of the electronic device 1.

The monitoring module 100 detects whether the display screen 11 is in the activated state. In one embodiment, if a user presses a key of the electronic device 1, the display screen 11 is activated.

The controlling module 101 controls the pressure sensor 12 to detect a pressure in a valid area on the display screen 11. In one embodiment, the valid area may be the entire area of the display screen 11 or a portion of the display screen 11. If the valid area is the portion of the display screen 11, the display screen 11 displays a range of the valid area. The user should press the valid area to unlock the display screen 11.

The reading module 102 reads a value of the pressure detected by the pressure sensor 12.

The detecting module 103 detects whether the value of the pressure is more than the predefined pressure value.

If the value of the pressure is more than the predefined pressure value, the unlocking module 104 unlocks the display screen 11.

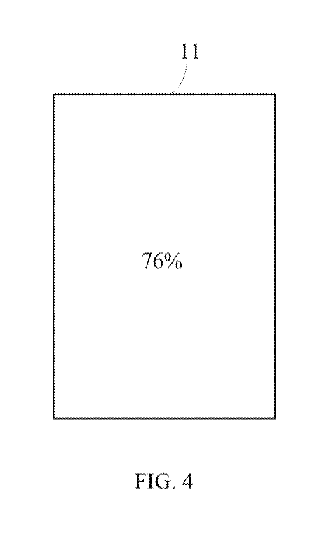

If the value of the pressure is less than the predefined pressure value, the prompting module 105 prompts the user that the pressure is too small so that the display screen 11 cannot be unlocked. In one embodiment, when the user presses the valid area on the display screen 11 with a finger, the display screen 11 displays a percentage, which indicates a ratio of the value of the pressure and the predefined pressure value. The user can see the percentage to control the pressure of the finger. As shown in FIG. 4, the display screen 11 displays the value “76%,” and the display screen 11 cannot be unlocked under the pressure.

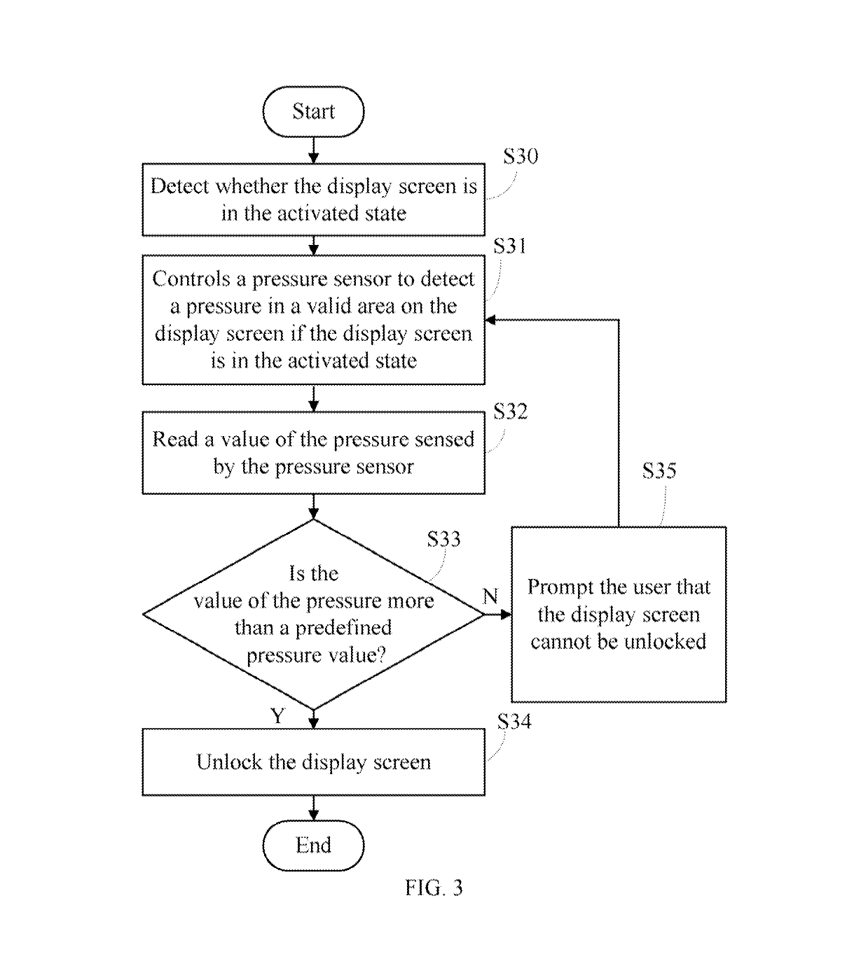

FIG. 3 is a flowchart illustrating a method for unlocking a display screen of the electronic device 1 in FIG. 1. Depending on the embodiment, additional steps may be increased, others removed, and the ordering of the steps may be changed.

In step S30, the monitoring module 100 detects whether the display screen 11 is in an activated state.

In step S31, if the display screen 11 is in the activated state, the controlling module 101 controls the pressure sensor 12 to detect a pressure in a valid area on the display screen 11.

In step S32, the reading module 102 reads a value of the pressure detected by the pressure sensor 12.

In step S33, the detecting module 103 detects whether the value of the pressure is more than the predefined pressure value. If the value of the pressure is more than the predefined pressure value, step S34 is implemented. If the value of the pressure is less than the predefined pressure value, step S35 is implemented.

In step S34, the unlocking module 104 unlocks the display screen 11.

In step S35, prompting module 105 prompts the value of the pressure is less than the predefined pressure value and the screen 11 will not be unlocked.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor; and
one or more programs stored in the storage system and executed by the at least one processor, the one or more programs comprising:
a controlling module that controls a pressure sensor to detect a pressure on a valid area of a display screen of the electronic device when the display screen is in an activated state;
a reading module that reads a value of the pressure from the pressure sensor; and
an unlocking module that unlocks the display screen when the value of the pressure is more than a predefined pressure value.

2. The electronic device as described in claim 1, wherein the one or more programs further comprises:
a prompting module that prompts that the value of the pressure is less than the predefined pressure value and the screen will not be unlocked.

3. The electronic device as described in claim 1, wherein the activated state of the display screen is a state that the display screen is locked but the display screen is lit by a background light.

4. The electronic device as described in claim 1, wherein the valid area is an entire area of the display screen or a portion of the display screen.

5. A method being executed by a processor of an electronic device for unlocking a display screen of the electronic device, comprising:
controlling a pressure sensor to detect a pressure on a valid area of the display screen of the electronic device when the display screen is in an activated state;
reading a value of the pressure from the pressure sensor; and
unlocking the display screen when the value of the pressure is more than a predefined pressure value.

6. The method as described in claim 5, further comprising:
prompting that the value of the pressure is less than the predefined pressure value and the screen will not be unlocked.

7. The method as described in claim 5, wherein the activated state of the display screen is a state that the display screen is locked but the display screen is lit by a background light.

8. The method as described in claim 5, wherein the valid area is an entire area of the display screen or a portion of the display screen.

9. A non-transitory storage medium having stored thereon instructions that, when executed by a processor, causes the processor to perform a method for unlocking a display screen of the electronic device, the method comprising:
controlling a pressure sensor to detect a pressure on a valid area of the display screen of the electronic device when the display screen is in an activated state;
reading a value of the pressure from the pressure sensor; and
unlocking the display screen when the value of the pressure is more than a predefined pressure value.

10. The non-transitory storage medium as described in claim 9, further comprising:
prompting that the value of the pressure is less than the predefined pressure value and the screen will not be unlocked.

11. The non-transitory storage medium as described in claim 9, wherein the activated state of the display screen is a state that the display screen is locked but the display screen is lit by a background light.

12. The non-transitory storage medium as described in claim 9, wherein the valid area is an entire area of the display screen or a portion of the display screen.
